(19) United States
(12) Patent Application Publication
(10) Pub. No.: US 2015/0147109 A1
(43) Pub. Date: May 28, 2015

(54) Security System

(71) Applicant: Clarence James McCarter, JR., Perris, CA (US)

(72) Inventor: Clarence James McCarter, JR., Perris, CA (US)

(21) Appl. No.: 14/092,923

(22) Filed: Nov. 28, 2013

(51) Int. Cl. E05B 73/00

(52) U.S. Cl. CPC E05B 73/0082
USPC 403/164

(57) ABSTRACT

A security system for securing a device by rotatably joining the device with a first object. The device may be protected from damage, yet still accessible while joined with the first object. The device includes electronic devices that function while joined with the first object. The device includes a device connection portion. The first object includes an object connection portion that joins with the device connection portion, often through a snapping mechanism. The device connection portion is circular to enable 360 degrees of rotation. A supporting body supports the device connection portion and includes a track for laterally carrying the device. A security portion, such as a band, joins the device to an object, such as a Forearm. A hook and a receiver on the security portion fasten the security portion around the object. A casing enables the first object to connect to the device.

### CROSS-REFERENCE TO RELATED APPLICATIONS

The present Utility patent application claims priority benefit of the [U.S. provisional application for patent Ser. No. 61/850,555 titled “Genie”, filed on Feb. 20, 2013 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to security of personal objects. More particularly, the invention relates to security of personal objects in a way which may allow use of objects while secured.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Users of electronic devices and other objects may experience difficulty in protecting and/or comfortably holding an object while using it. Although some available solutions may provide means for securing an object, these solutions may be ineffective at allowing users to use a secured device in certain ways.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. One such aspect of the prior art shows a holder for an electronic device which is configured to allow adjustment of the yaw, pitch, and roll of the device. By way of educational background, another aspect of the prior art generally useful to be aware of teaches of a protective holder for a mobile device which incorporates a rotating mechanism which may be used for swiveling the mobile device from portrait or landscape positions and vice-versa while inserted in the holder. Finally, another aspect of the prior art discloses of an attachment mechanism which may allow 360 degree rotation about the attachment mechanism. However, these solutions may not provide sufficient usability and/or security of secured devices. A solution which provided secure mounting capability as well as capability to move in a variety of directions would be desirable.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 and FIG. 2 are illustrations of an exemplary first object and an exemplary device for securing the first object to a second object, in accordance with an embodiment of the present invention;

FIG. 3 is an illustration of an exemplary device having multiple securing portions, in accordance with an embodiment of the present invention;

FIG. 4 is an illustration of an exemplary casing for an object, in accordance with an embodiment of the present invention; and

FIG. 5 is an illustration of an exemplary casing having adjustable parts, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Some embodiments of the present invention may provide means for securing a first object to a second object and/or using the first object while in a secured position. In some embodiments, the first object may be an electronic device, such as, without limitation, a smartphone, mp3 player, compact disc player, tablet, or personal digital assistant. In alternative embodiments, the first object may be any non-electronic device, including, without limitation, a book, water bottle, or a motion-activated device. In many embodiments, the second object may be anything suitable for securing against, including, without limitation, a body part, a car dashboard, or a clothing item. In some embodiments, the first object may be adjustable while secured to allow improved use of the object. In a non-limiting example, a user may tilt the object in any direction, spin the object 360 degrees in a clockwise and/or counterclockwise direction, move the object laterally along a band, and pull the first object away from the second object a certain distance while maintaining a secured state.

In one embodiment of the present invention, a security system is operable to secure a device by rotatably joining the device with a first object. The device may be protected from damage, yet still accessible while joined with the first object. The device includes electronic devices that function while joined with the first object. The device includes a device connection portion. The first object includes an object connection portion that joins with the device connection portion, often through a snapping mechanism. The device connection portion is circular to enable 360 degrees of rotation. A supporting body supports the device connection portion and includes a track for laterally carrying the device. A security portion, such as a band, joins the device to an object, such as a Forearm. A hook and a receiver on the security portion fasten the security portion around the object. A casing enables the first object to connect to the device. In some embodiments of the present invention, depending upon the needs of the particular application, depending upon the needs of the particular application, the casing may be configured to be at least water resistant, or fully waterproof.

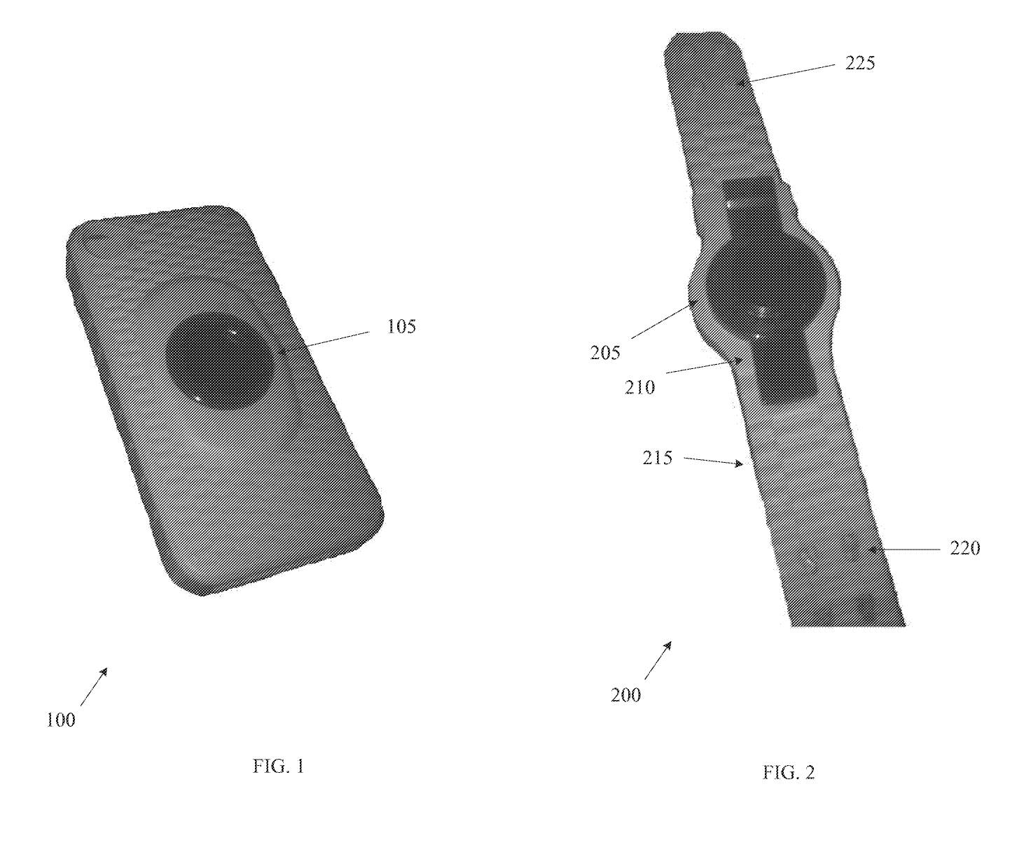

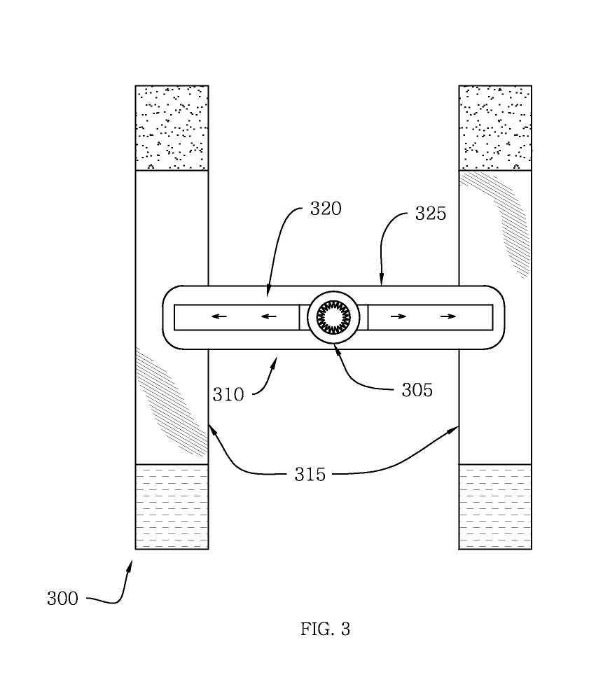

FIG. 1 and FIG. 2 are illustrations of an exemplary first object and an exemplary device for securing the first object to a second object, in accordance with an embodiment of the present invention. In the present embodiment, the device 200 may have a device connection portion 205. In some embodiments, the device connection portion 205 may be any size and/or shape. In a non-limiting example, the device connection portion 205 may be circular to allow for easier rotation of a first object. In an alternative non-limiting example, the device connection portion 205 may be rectangular with a pivoting/rotating base to allow rotation of a first object. In some embodiments, the device connection portion 205 may be configured to receive a first object 100. In the present embodiment, the first object 100 may have an object connection portion 105 for mating with the device connection portion 205. In some embodiments, the object connection portion 105 may connect to the device connection portion 205 by any suitable means, including, without limitation, ball joints, magnets, screws, frictional force, or hooks. In a non-limiting example, a user may push an object connection portion 105 against a device connection portion 205 until the object connection portion 105 pops into place. In some embodiments, the device connection portion may include a stabilizing joint for enhancing stability during rotation of the device. In alternative embodiments, a device 200 may be designed to also secure objects which may not have an object connection portion 105. In some of these embodiments, the device connection portion 205 may have components suitable for joining with objects of various sizes and/or shapes. In a non-limiting example, a device connection portion 205 may have extendable straps which may extend over an object. In the present embodiment, the device 200 may have a supporting body 210 connected to the device connection portion 205. In some embodiments, the device connection portion 205 may move along the supporting body 210 to allow for lateral movement of an object 100 which may be connected to the device connection portion 205. In many embodiments, a device 200 may also have a securing portion 215. In the present embodiment, the securing portion 215 may extend directly from the device connection portion 205, similar to a watch band. In other embodiments, device may incorporate other types of securing portions 215 and/or securing portions 215 which may extend from other components, such as, without limitation, a supporting body. In some embodiments, a securing portion 215 may be designed to wrap around an object and attach to itself using any suitable means, including, without limitation, Velcro, hooks, magnets, or an adhesive. In the present embodiment, the securing portion 215 may have hooks 220 for attaching to receivers 225 on the securing portion 215. In alternative embodiments, the securing portion 215 may attach to an object. In a non-limiting example, a securing portion 215 may use a magnet to attach to a metallic surface.

In some embodiments, a secured object 100 may rotate in either direction around a device 200. In alternative embodiments, an object connection portion 105 may rotate on a one-way gear, which may not allow rotation in one direction.

FIG. 3 is an illustration of an exemplary device having a plurality of securing portions, in accordance with an embodiment of the present invention. In the present embodiment, the device 300 may have a connection portion 305, a supporting body 310, and plurality of securing portions 315 which may extend perpendicularly from the supporting body 310. In some embodiments, a device 300 having multiple securing portions 315 may allow for improved stability. In other embodiments, a device 300 may have a single securing portion 315 which may extend perpendicularly from the supporting body 310. In some embodiments, securing portions 315 may extend from a connection portion 305 and or a supporting body 310 in any direction. In the present embodiment, a supporting body 310 may have multiple parts, including, without limitation, a track 320 and an outer supporting body 325. In some embodiments, the connection portion may move laterally along the track 320.

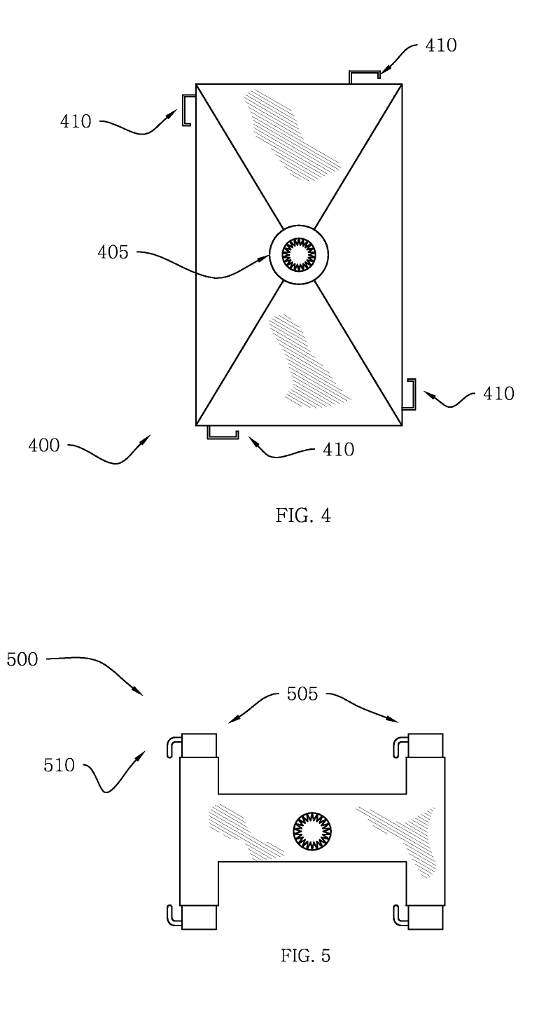

FIG. 4 is an illustration of an exemplary casing for an object, in accordance with an embodiment of the present invention. In some embodiments, a first object 100 may have a casing 400 to allow the first object 100 to effectively connect to a device 200. In the present embodiment, a casing 400 may be designed to fit onto an electronic device, such as, without limitation, a smartphone or tablet. Further, in the present embodiment, the casing 400 may have clamps 410 to connect the casing 400 to the first object 100. In some embodiments, any means of connecting a casing 400 to an object 100 may be suitable. In the present embodiment, the casing 400 may have an object connection portion 405 for connecting to a device connection portion 205.

FIG. 5 is an illustration of an exemplary casing having adjustable parts, in accordance with an embodiment of the present invention. In the present embodiment, a casing 500 may have a plurality of extendable arms 505 which may extend to receive varying sizes of objects 100. Further, in the present embodiment, the plurality of extendable arms 505 may include a plurality of hooks 510 to effectively grip an object 100.

In some embodiments, components may be composed of any suitable materials, including, without limitation, plastic, metal, rubber, aluminum, or titanium. In a non-limiting example, a securing portion 215 may be composed of silicon rubber, nylon, and/or hard plastic, and a connection portion 205 may be composed of titanium. In some embodiments, a supporting body 310 may be composed of a flexible material to allow a secured object 100 to tilt forward and backward.

In some alternative embodiments, a cord or other similar device may connect to both a device connection portion 205 and an object connection portion 105 to establish a connection between a device 200 and an object 100. In some of these embodiments, the cord may be retractable, so that a user may pull an object 100 a certain distance away from a device 200, but the object 100 may retract to the device 200 when the user lets go.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing security of personal objects according to the present invention will be apparent to those skilled in the art. Various aspects of the invention have been described above by way of illustration, and the specific embodiments disclosed are not intended to limit the invention to the particular forms disclosed. The particular implementation of the security of personal objects may vary depending upon the particular context or application. By way of example, and not limitation, the security of personal objects described in the foregoing were principally directed to electronic device implementations; however, similar techniques may instead be applied to any personal object, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A system comprising:
a first object, said first object being configured to at least partially provide protection and a secure connection, said first object comprising an object connection portion for at least partially enabling said secure connection; and
a device, said device being configured to rotatably join with said first object, said device further being configured to perform a function while rotatably joined with said first object, said device comprising a device connection portion, said device connection portion being configured to at least partially receive said object connection portion for joining said first object with said device, said device connection portion comprising a stabilizing joint for enhancing stability during rotation of said device, said device further comprising a supporting body, said supporting body being configured to support said device connection portion, said device further comprising a securing portion, said securing portion being configured to join said device with an object.

2. The system of claim 1, in which said device comprises an electronic device.

3. The system of claim 2, in which said device connection portion comprises a substantially circular shape to facilitate rotation while joined with said object connection portion.

4. The system of claim 3, wherein said device rotates in two directions up to 360 degrees while joined with said first object.

5. The system of claim 4, wherein said object connection portion joins with said device connection portion through a ball joint and a socket, said connection between said object connection portion and said device connection portion at least partially generating a snapping effect during engagement.

6. The system of claim 5, wherein a retractable cord joins said object connection portion with said device connection portion.

7. The system of claim 6, in which said device connection portion comprises a metal material.

8. The system of claim 7, in which said supporting body comprises a track.

9. The system of claim 8, wherein said device connection portion moves laterally along said track.

10. The system of claim 9, in which said securing portion comprises a band or Strap's

11. The system of claim 10, in which said securing portion comprises a hook and a receiver, said hook and said receiver being configured to at least partially fasten said securing portion around said object.

12. The system of claim 11, in which said securing portion comprises a rubber or nylon

13. The system of claim 12, in which said securing portion comprises a plurality of securing portions, said plurality of securing portions being disposed to extend perpendicularly from said supporting body.

14. The system of claim 13, in which said first object comprises a casing, said casing being configured to at least partially enable said first object to join with said device.

15. The system of claim 14, in which said casing comprises a plurality of clamps.

16. The system of claim 15, wherein said plurality of clamps are configured to join said casing to said first object.

17. The system of claim 14, in which said casing is a hard plastic shell see through screen protection material and is configured to be at least water resistant, if not waterproofed. And comprises a plurality of clamps.

18. The system of claim 17, in which said plurality of extendable arms comprise a plurality of hooks, said plurality of hooks being configured to enhance a grip on said objects.

19. A system comprising:
means for orienting a device to join with a first object;
means for providing a casing for at least partially enabling said first object to join with said device;
means for joining a device connection portion with an object connection portion;
means for protecting said device with said first object;
means for securing said device and said first object to an object with a securing portion;
means for rotating said device while joined with said first object; and
means for detaching said device from said first object to perform a function.

20. A system consisting of:
a first object, said first object being configured to at least partially provide a secure connection, said first object comprising an object connection portion for at least partially enabling said secure connection;
a device, said device comprising an electronic device, said device being configured to rotatably join with said first object, said device further being configured to provide a function while rotatably joined with said first object, said device comprising a device connection portion, said device connection portion comprising a substantially circular shape for facilitating rotation of said device, said device connection portion being configured to at least partially receive said object connection portion for joining said first object with said device, said device connection portion further being configured to join with said object connection portion through a ball joint and a socket, said connection between said object connection portion and said device connection portion at least partially generating a snapping effect during engagement, said device connection portion comprising a stabilizing joint for enhancing stability during rotation of said device, said device connection portion further comprising a metal material, said device further comprising a supporting body, said supporting body being configured to support said device connection portion, said supporting body comprising a track, said track being configured to at least partially carry said device connection portion laterally along said supporting body, said device further comprising a securing portion, said securing portion being configured to join said device with an object, said securing portion comprising a band, said securing portion further comprising a rubber or nylon material; and
a casing said casing being configured to at least partially enable said first object to join with said device; said casing comprising a plurality of clamps, said plurality of clamps being configured to join said casing to said first object, said casing further comprising a plurality of extendable arms, said plurality of extendable arms being configured to extend for at least partially receiving varying sizes of objects, said plurality of extendable arms comprising a plurality of hooks, said plurality of hooks being configured to enhance a grip on said objects.
